(19) United States
(12) Patent Application Publication
(10) Pub. No.: US 2014/0164916 A1
(43) Pub. Date: Jun. 12, 2014

(54) Means for Transitioning Between Hierarchical Representations of Organized Thought

(71) Applicant: John Vasconcellos, San Francisco, CA (US)

(72) Inventor: John Vasconcellos, San Francisco, CA (US)

(21) Appl. No.: 14/097,248

(22) Filed: Dec. 5, 2013

Related U.S. Application Data
(60) Provisional application No. 61/734,381, filed on Dec. 7, 2012.

(51) Int. Cl. G06F 17/21; G06F 3/0488

(52) U.S. Cl. CPC G06F 17/211; G06F 3/04883
USPC 715/249; 715/732

(57) ABSTRACT

A software means for alternating between corresponding hierarchical representation of organized thought such as a bubble map format and an outline format to be used with hand held computerized devices such as mobile phones and tablet computers wherein the device is rotated so as to cause a landscape or portrait orientated display. Upon rotation, a user alternates from, for example, a bubble map format in landscape mode to an outline format in portrait mode while maintaining all thoughts stored in either format. Alternative means for switching between formats include swiping the screen as a form of processing instruction, and viewing of each though in a slideshow format with a dropdown menu permitting navigation between all thoughts in a hierarchical format.

### CROSS REFERENCE TO RELATED APPLICATIONS

This application depends from provisional application No. 61/734,381 filed on Dec. 7, 2012.

### STATEMENT REGARDING FEDERALLY SPONSORED RESEARCH OR DEVELOPMENT

Not Applicable.

### BACKGROUND OF THE INVENTION

1. Field of the Invention

The present invention relates to hierarchical representations of organized thought including but not limited to “bubble map” and “outline” formats. The present invention also relates to handheld computerized devices that employ a display means capable of switching between landscape and portrait display orientation modes.

2. Description of Related Art

The current related art contains a plurality of means for creating hierarchical representations including word processing, spreadsheets, slide presentation means, and combinations thereof with which to develop, process, and display organized thought. The prior art also contains means for switching between portrait and landscape mode for handheld computerized devices including a means for enabling display mode changes upon rotation of said devices on a plane horizontal to said display means. The current art, however, does not contain means for switching between different representations of organized thought by using the above display mode switching means, the advantages of which are described below.

### SUMMARY OF THE INVENTION

The present invention comprises a software application means for quickly transitioning between hierarchical representations of organized thought on handheld computers such as tablet computers and certain mobile phone types. In a preferred embodiment, a user begins quickly putting down less organized thoughts into bubble shaped areas in a Bubble Map format that is displayed while a device is in landscape orientation. Upon rotation of the device into portrait orientation, the thoughts entered into the bubble areas in Bubble Map format are converted into a more linear hierarchical representation of a traditional Outline format. Changes made in one format are also represented upon switching into the other format. In an alternative embodiment, a user swipes the screen to switch between hierarchical formats.

It is therefore an object of the present invention to comprise a means for quickly capturing a series of related thoughts into a simple format.

It is another object of the present invention to comprise a means for converting thoughts made in one representational format into a different representational format.

It is another object of the present invention to take advantage of the portability of handheld devices whereby their small size enables a user to carry said devices with them permitting the use of the device to capture a thought into a hierarchical format at any given moment before the thought is forgotten.

It is another object of the present invention to take advantage of a mode change signal uniquely employed by handheld devices whereby rotation of a device between portrait and landscape orientation causes a sensor means to create said signal, and whereby said signal enables the present invention to convert between representational formats dependent upon which display mode is positionally indicated.

It is another object of the present invention to convert any captured thoughts into more organized representations with the ultimate goal of creating a complete argument comprised of all captured thoughts after transition into a hierarchical representation.

The characteristics and utilities of the present invention described in this summary and the detailed description below are not all inclusive. Many additional features and advantages will be apparent to one of ordinary skill in the art given the following description. There has thus been outlined, rather broadly, the more important features of the invention in order that the detailed description thereof that follows may be better understood, and in order that the present contribution to the art may be better appreciated.

In this respect, by explaining at least one embodiment of the invention in detail, it is to be understood that the invention is not limited in its application to the details of construction and to the arrangements of the components set forth in the description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

The characteristics and utilities of the present invention described in this summary and the detailed description below are not all inclusive. Many additional features and advantages will be apparent to one of ordinary skill in the art given the following detailed description.

### BRIEF DESCRIPTION OF THE DRAWINGS

FIG. 1A is a plain view of a computerized hand held device display in landscape orientation and showing an example of a bubble map format representation.

FIG. 1B is a plain view of a computerized hand held device display in portrait orientation showing the bubble map representation of FIG. 1A in an outline format.

### DETAILED DESCRIPTION

The present invention is a software means for alternating between different representations of organized thoughts on a computerized hand held device. Different representational formats are used to alternatingly display the same information when a user transitions their device from landscape to portrait orientation or vice versa. Said devices employ a mode change signal wherein a signal is processed by the device to indicate a change in display orientation depending on which edge of the device is higher than the remaining edges. The present invention employs the mode change signal to cause a corresponding representation format to be displayed so that different formats may be alternatingly displayed to show the same hierarchical argument.

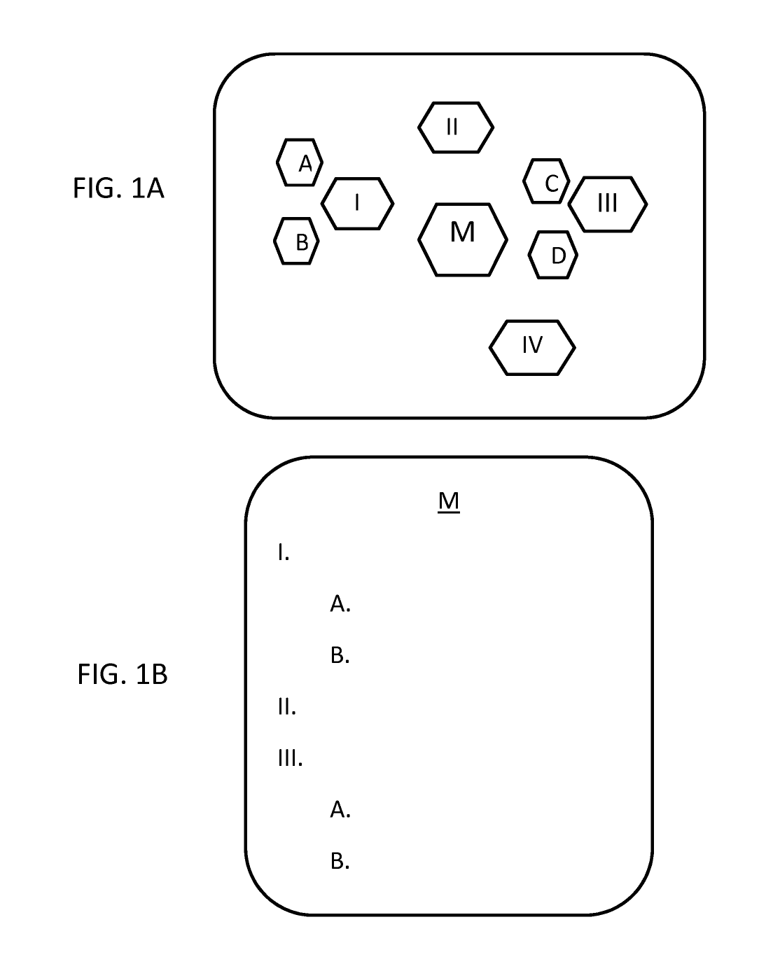

FIG. 1A shows a landscape orientation wherein a bubble map format has been used to organize an argument. A main topic M populates the center bubble. Bubbles I, II, III, IV that are slightly smaller in size than the center bubble M surround the center bubble and are referred to herein as topic bubbles. Topic bubble I is in turn surrounded by smaller subtopic bubbles A and B. Topic bubble III is surrounded by subtopic bubbles C and D. Upon rotating to the portrait orientation, the representational format transitions to outline format and maintains the hierarchical structure of the bubble map. Subtopic bubbles C and D become labeled as subtopics A and B in FIG. 1B in following the structural format of the outline representation. In a first alternative embodiment, a user swipes the screen in order to switch between hierarchical formats instead of rotating the screen. In a second alternative embodiment, a slideshow format is employed whereby a user views one hierarchical thought at a time within a format by transitioning between slides organized by the hierarchical format; a drop down menu permits navigation to any point in the hierarchy to view the associated slide. It is anticipated that different representation formats may be used with the present invention other than the bubble map and outline formats described above, and that alternative but known means may be employed to switch between hierarchical formats.

The previous is a detailed description of embodiments of the present invention. As these embodiments of the present invention are described, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, the description is not to be considered in a limiting sense, as it is understood that the present invention is in no way limited to the embodiments described.

What is claimed is:

1. A software application that stores a plurality of hierarchical formats whereby said formats are organized by structural components that each correspond to a structural component within all other of said formats and whereby entry of thoughts into a first hierarchical format are automatically stored as thoughts within said corresponding structural components of all other said hierarchical formats; said software application further comprising a switching means causing a transition between views of the different but corresponding hierarchical formats.

2. The switching means of claim 1 including but not limited to: rotating a device between landscape and portrait orientation; swiping a device screen whereby swiping is commonly understood to be a directional finger or hand motion across a computer screen capable of responding to finger or hand contact as a means for causing a processing instruction; and a slideshow format including a dropdown menu whereby each thought is viewed as a single slide but navigation within the hierarchy can be achieved by employing said dropdown menu containing one or more complete or partial hierarchical formats.
